(19) United States
(12) Patent Application Publication
(10) Pub. No.: US 2017/0175427 A1
(43) Pub. Date: Jun. 22, 2017

(54) MAGNETIC STRIKE PLATE SYSTEM

(71) Applicant: David Wirth, Riverhead, NY (US)

(72) Inventor: David Wirth, Riverhead, NY (US)

(21) Appl. No.: 15/368,560

(22) Filed: Dec. 2, 2016

Related U.S. Application Data
(60) Provisional application No. 62/262,153, filed on Dec. 2, 2015.

(51) Int. Cl. E05C 19/16; E05F 5/00; E05B 47/00

(52) U.S. Cl. CPC E05C 19/163; E05B 47/004; E05B 47/0046; E05F 5/00

(57) ABSTRACT

A door set assembly for use with a door having a latch portion and a magnetized strike plate, comprising a top face, a bottom face, and a protrusion extending below said bottom face of said strike plate. The protrusion is formed by two side walls and a far wall extending from said top face of strike plate and a graded floor angled away from said top face of said strike plate, the combination of said walls and said floors forming a latch receiving channel, such that when the door is swung into the closed position the magnetized strike plate gradually actuates the latch of said latch portion along the entire length of said channel, from a fully retracted position to a fully extended position until said far wall of said strike plate channel holds the latch in place to keep the door in the closed position.

### CROSS REFERENCE TO RELATED APPLICATION

This application claims priority from U.S. Provisional Application Ser. No. 62/262,153 filed on Dec. 2, 2015, which is incorporated by reference in its entirety herein.

### BACKGROUND OF THE INVENTION

Field of Invention

This invention generally relates to door sets for use with hinged doors having no door stops. More particularly this invention relates to a magnetic strike plate having a latch receiving portion capable of actuating the door latch, while simultaneously acting as a door stop to prevent the hinged door from pivoting about its vertical axis of rotation, out of its “closed” position.

Prior Art

The advent of modern architecture and minimalist interior design has created a need for doors and door casings without door stops. The absence of door stops however, would result in hinged doors pivoting about their vertical axis of rotation, out of their “closed” position. Thus, the advent of modern architecture and interior design has created a need for a door set which is aesthetically pleasing and wherein at least one of its components can also act as a door stop.

### SUMMARY OF THE INVENTION

Accordingly, it is an object of the present invention to provide a door set which is aesthetically pleasing and wherein at least one of its components can also act as a door stop.

It is a further object of the present invention to provide a door set having a latch portion and a strike plate, which acts as the door stop.

In accordance with the present invention, there is provided a door set assembly for use with a door, said door set having a latch portion and a strike plate. The strike plate comprises a top face and a bottom face. It is further provided with a latch receiving channel, said channel being defined by three walls extending down from and optionally being perpendicular to the top face of strike plate and a graded floor angled away from the top surface, whereby the three channel walls and the graded floor form a protrusion below the bottom surface of the strike plate. The strike plate is magnetized. As the door swings into a closed position the magnetic force of the strike plate gradually actuates the latch along the channel, from a fully retracted position to a fully extended position until the far wall of the strike plate channel stops the pivoting of the door and the magnetized strike plate holds the latch in place to prevent it from opening.

These and other objects, advantages, features, and characteristics of the invention will be apparent from the following description of a preferred embodiment, considered along with the accompanying drawings.

### BRIEF DESCRIPTION OF THE DRAWINGS

It is believed that the present invention will be better understood from the following detailed description taken in conjunction with the accompanying drawings, in which the numerals represent identical elements and wherein:

FIGS. 1-31 are various views of the inventive door set and more particularly of the inventive strike plate in said door set.

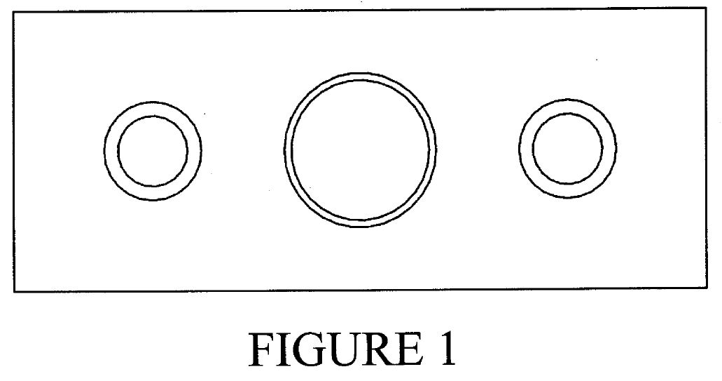

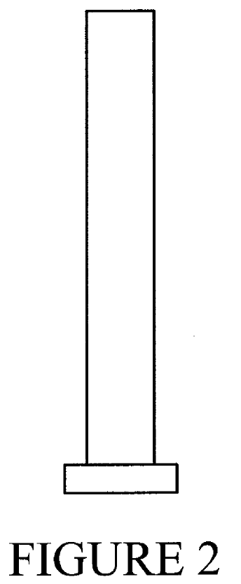

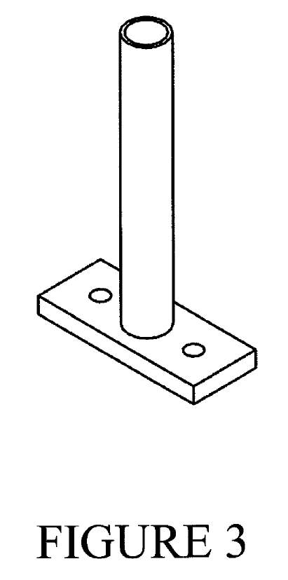

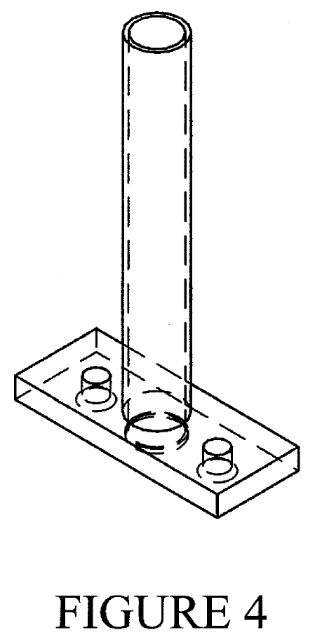

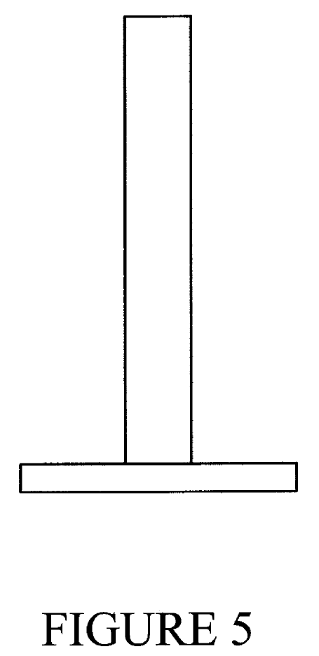

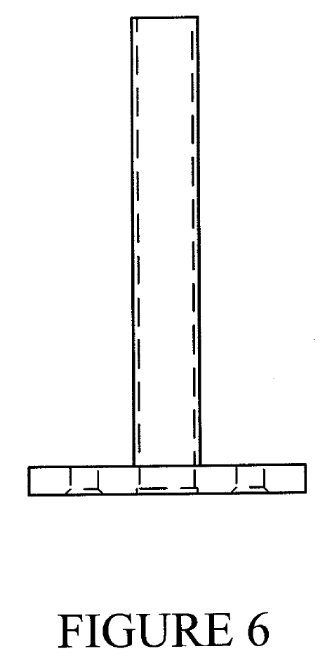

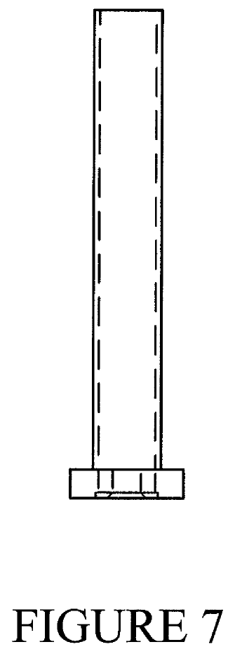

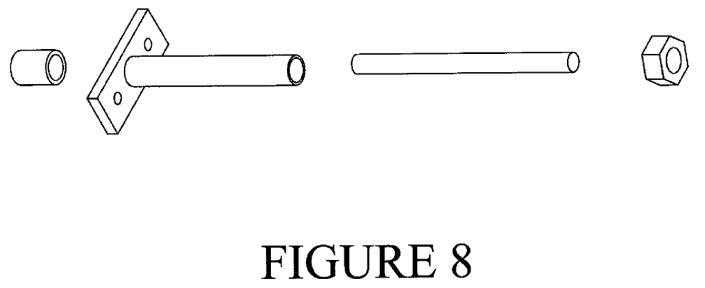

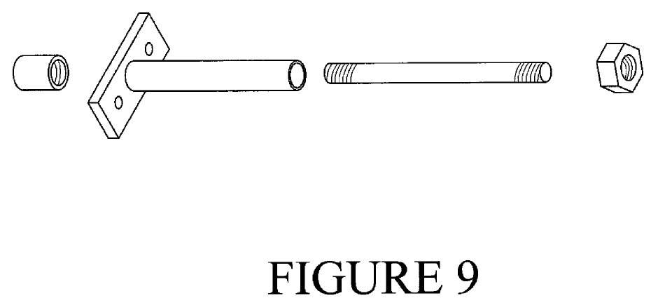

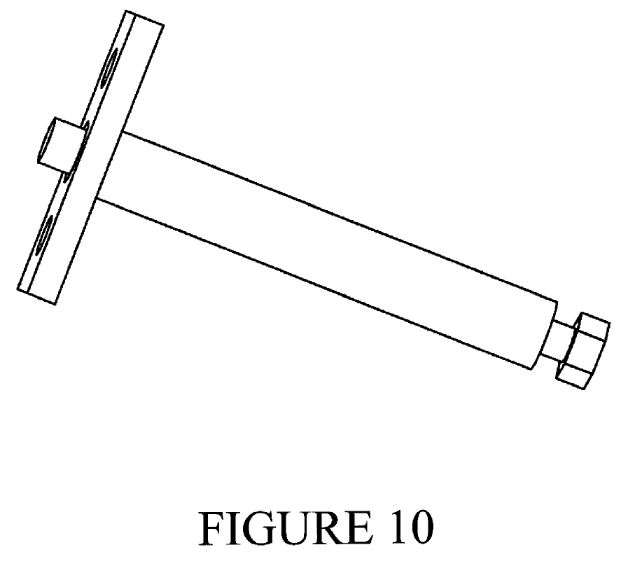

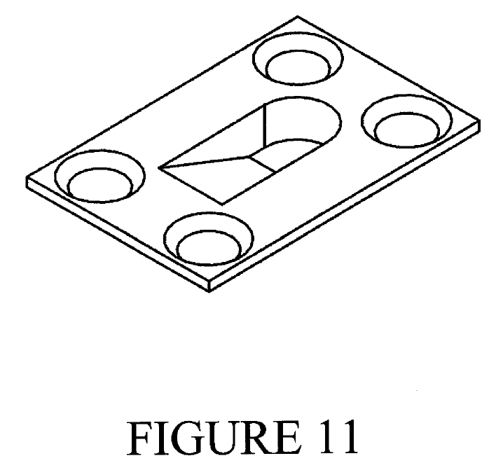

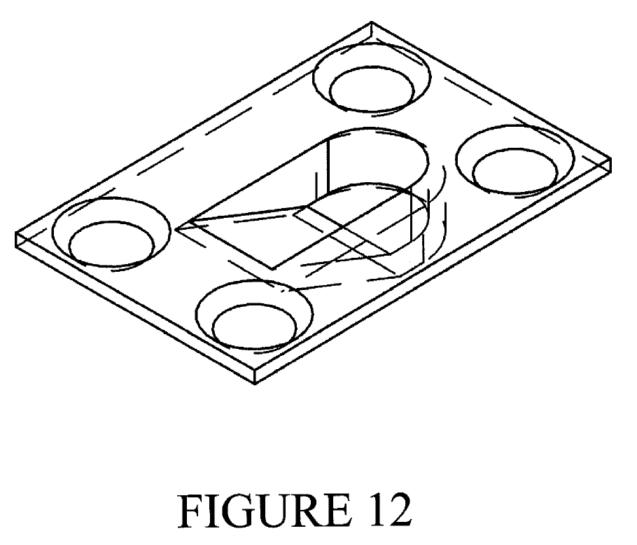

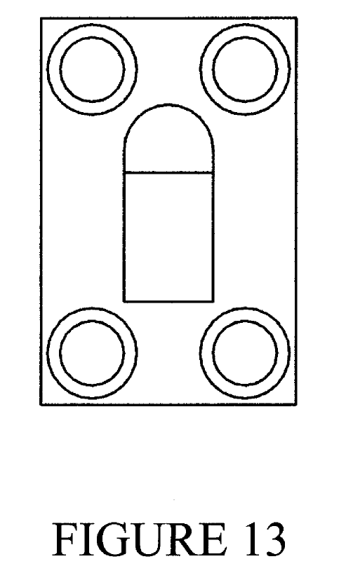

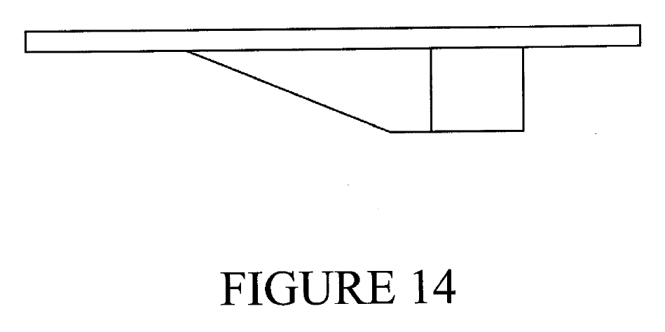

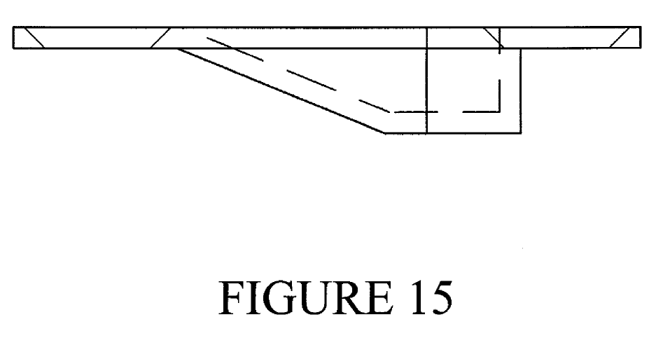

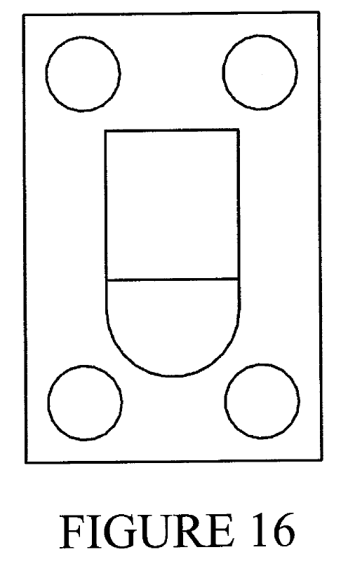

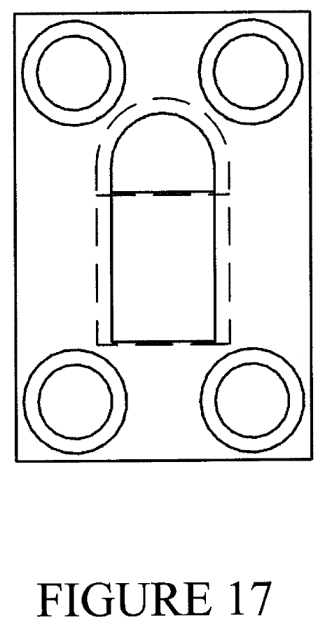

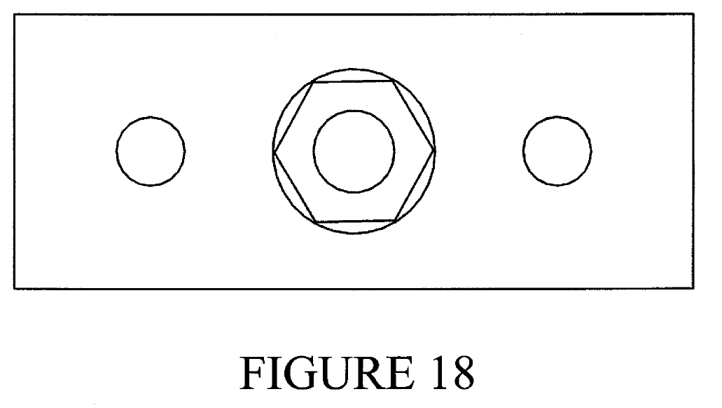

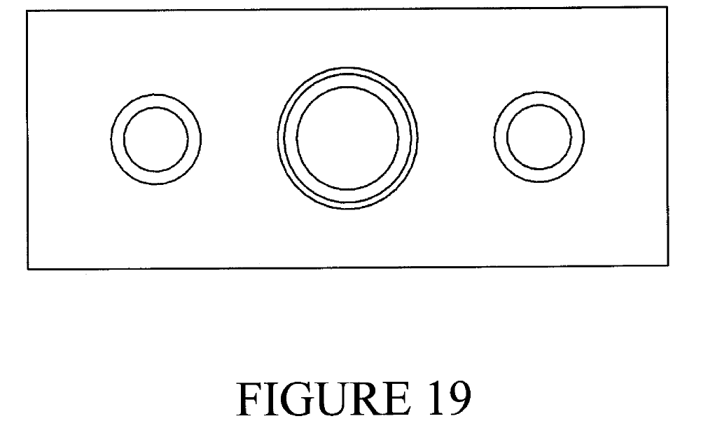

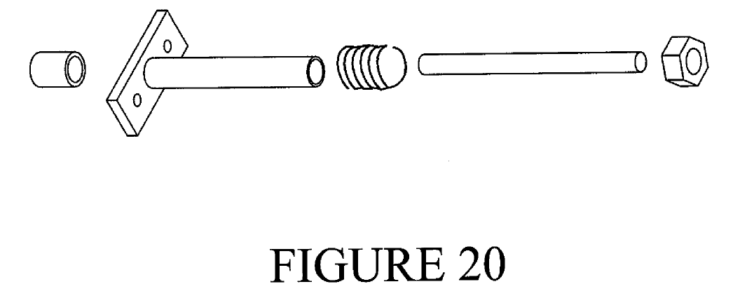

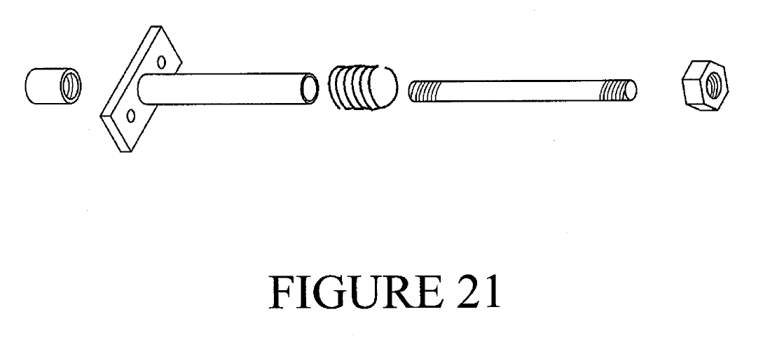

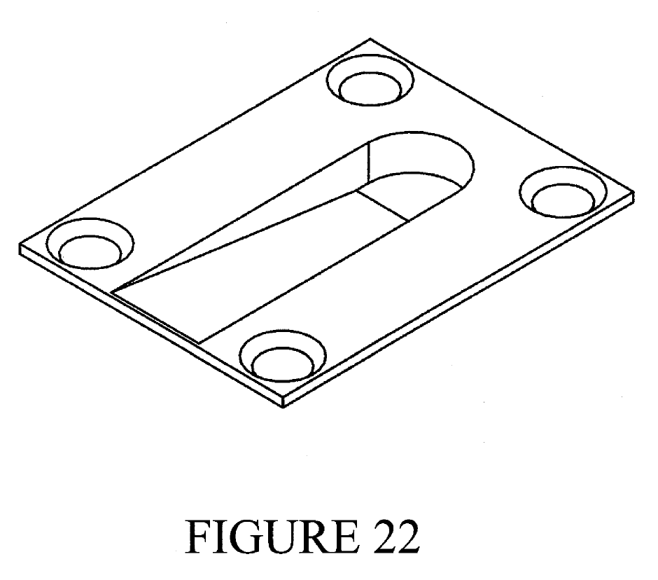

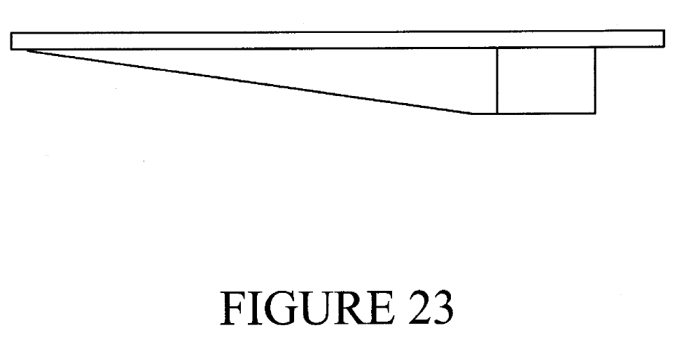

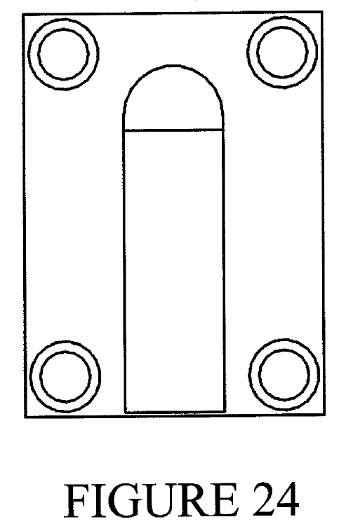

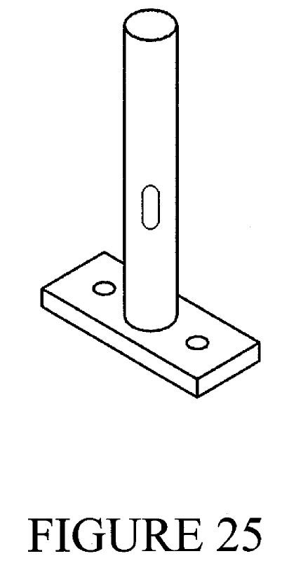

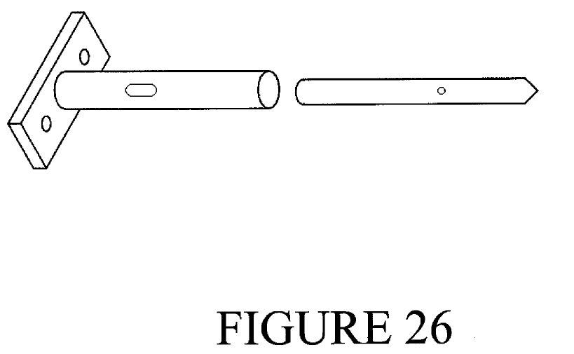

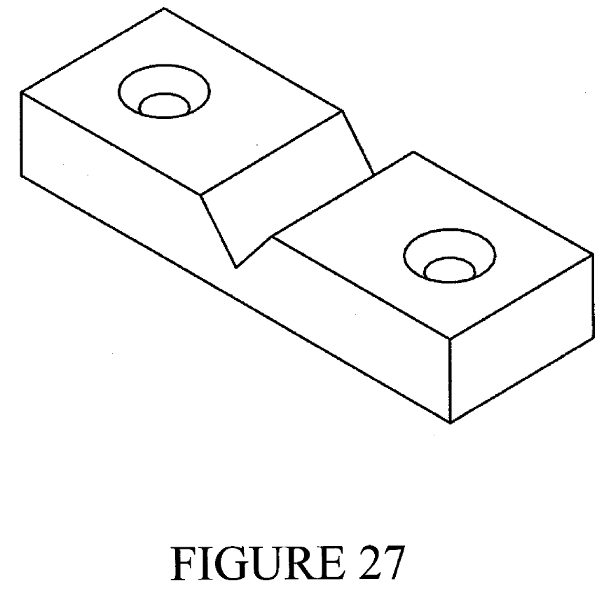

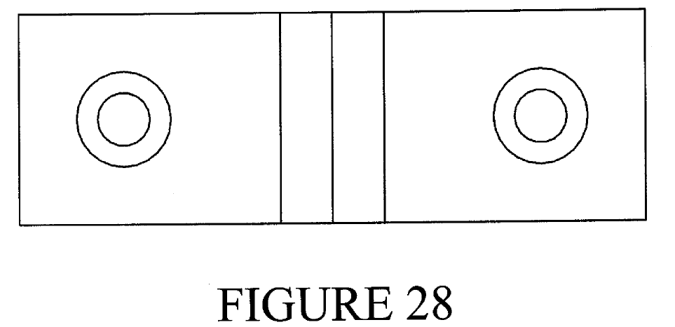

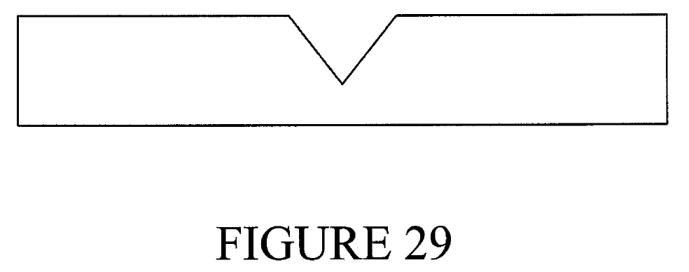

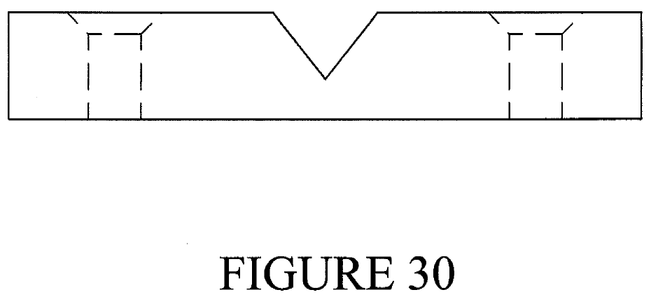

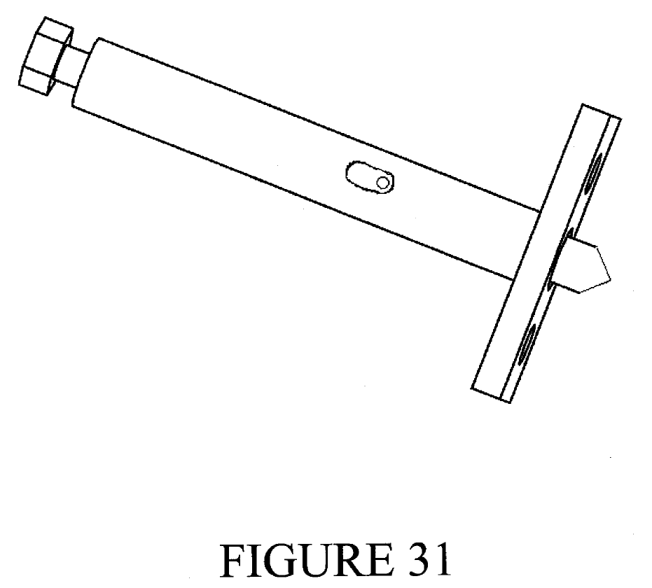

### DETAILED DESCRIPTION OF THE INVENTION

In accordance with the present invention, there is provided a door set assembly for use with a door, said door set having a latch portion and a strike plate. The strike plate comprises a top face and a bottom face. It is further provided with a latch receiving channel, said channel being defined by three walls extending down from and optionally being perpendicular to the top face of strike plate and a graded floor angled away from the top surface, whereby the three channel walls and the graded floor form a protrusion below the bottom surface of the strike plate. The strike plate is magnetized. As the door swings into a closed position the magnetic force of the strike plate gradually actuates the latch along the channel, from a fully retracted position to a fully extended position until the far wall of the strike plate channel stops the pivoting of the door and the magnetized strike plate holds the latch in place to prevent it from opening.

The latch portion comprises a trim plate provided with a cylindrical housing, said housing having a bore running its entire length. One end of the housing is open and the other end is capped off. Dispensed inside the housing is a pin, or bolt, or latch.

In one embodiment the bolt comprises two parts. A shaft having two ends. Optionally both ends of the shaft could be threaded. One threaded end receives a magnetic head. The other end is provided with means to allow the shaft to move from a retracted position within the housing to an extended position beyond the open end of the housing.

The process of installing the latch portion comprises the steps of boring into the door a length that will permit the housing to be inserted so that the trim plate is flush with the door.

While particular embodiments of the invention have been illustrated and described in detail herein, they are provided by way of illustration only and should not be construed to limit the invention. Since certain changes may be made without departing from the scope of the present invention, it is intended that all matter contained in the above description, or shown in the accompanying drawings be interpreted as illustrative and not in a literal sense. Practitioners of the art will realize that the sequence of steps and the embodiments depicted in the figures can be altered without departing from the scope of the present invention and that the illustrations contained herein are singular examples of a multitude of possible depictions of the present invention.

Accordingly, I claim:

1. A door set assembly for use with a door having a latch portion and a strike plate; said strike plate being magnetized and comprising a top face, a bottom face, and a protrusion extending below said bottom face of said strike plate;
said protrusion being formed by two side walls and a far wall extending from said top face of strike plate and a graded floor angled away from said top face of said strike plate, the combination of said walls and said floors forming a latch receiving channel, such that when the door is swung into the closed position the magnetized strike plate gradually actuates the latch of said latch portion along the entire length of said channel, from a fully retracted position to a fully extended position until said far wall of said strike plate channel holds the latch in place to keep the door in the closed position.
